(19) United States
(12) Patent Application Publication
(10) Pub. No.: US 2025/0354245 A1
(43) Pub. Date: Nov. 20, 2025

(54) Masking System

(71) Applicant: Chromalloy Gas Turbine LLC, Palm Beach Gardens, FL (US)

(72) Inventors: Martinus Adam Petrus van den Bosch, Tilburg (NL); Fabian van Tilt, Tilburg (NL); Zachary Oras, Riverview, FL (US); Zachary Hopkins, San Diego, CA (US)

(21) Appl. No.: 18/668,147

(22) Filed: May 18, 2024

(51) Int. Cl. C23C 4/02

(52) U.S. Cl. CPC C23C 4/02

(57) ABSTRACT

A masking system for selectively masking a component includes a first piece, a second piece, and a third piece. The first piece has a groove. The second piece has a projection, a first channel, and a second channel. The third piece has a first wall, a second wall, a first sidewall, and a second sidewall. The first sidewall has a first notch. The groove is configured to receive the projection to connect the first piece and the second piece. The second wall of the third piece is configured to be insertably received by the first channel and the second channel such that a portion of the component is accessible via the first notch.

### CROSS REFERENCE TO RELATED APPLICATIONS

None.

### FIELD OF THE DISCLOSURE

The disclosure relates generally to the field of masking systems. More specifically, the disclosure relates to an interlocking masking system for selectively masking a part for a high-temperature process.

### SUMMARY

The following presents a summary of the invention in order to provide a basic understanding of some aspects of the invention. This summary is not an extensive overview of the invention. It is not intended to identify critical elements of the invention or to delineate the scope of the invention. Its sole purpose is to present some concepts of the invention in a simplified form as a prelude to the more detailed description that is presented elsewhere herein.

In an aspect of the disclosure, a masking system for selectively masking a component includes a first piece, a second piece, and a third piece. The first piece has a groove. The second piece has a projection, a first channel, and a second channel. The third piece has a first wall, a second wall, a first sidewall, and a second sidewall. The first sidewall has a first notch. The groove is configured to receive the projection to connect the first piece and the second piece. The second wall of the third piece is configured to be insertably received by the first channel and the second channel such that a portion of the component is accessible via the first notch.

In an aspect, according to any one of the preceding aspects, the second piece has a top wall that includes a cutout.

In an aspect, according to any one of the preceding aspects, the first channel and the second channel are accessible via the cutout.

In an aspect, according to any one of the preceding aspects, the groove is a frusto-rectangular groove.

In an aspect, according to any one of the preceding aspects, the projection is a frusto-rectangular projection.

In an aspect, according to any one of the preceding aspects, the masking system includes a fourth piece having a first wall and a second wall connected by an angled wall.

In an aspect, according to any one of the preceding aspects, the component is a gas turbine component.

In an aspect, according to any one of the preceding aspects, the component is a fan disc.

In an aspect, according to any one of the preceding aspects, the fan disc includes a post having a wear plate.

In an aspect, according to any one of the preceding aspects, the portion is a wear plate.

In an aspect, according to any one of the preceding aspects, a height of the second wall is greater than a height of the first wall.

In an aspect, according to any one of the preceding aspects, the masking system is toolless.

In an aspect, a masking system for selectively masking a disc is disclosed. The disc has a stop, and the stop includes a post with a wear plate. The masking system includes a first piece, a second piece, and a third piece. The second piece has a first channel and a second channel. The first channel opposes the second channel. The third piece has a first wall, a second wall, a first sidewall, and a second sidewall. The first sidewall has a first notch. The first piece is configured to be connected to the second piece in an end-to-end configuration. The second wall of the third piece is configured to be insertably received by the first channel and the second channel such that the first notch corresponds to the wear plate when the third piece is on the post.

In an aspect, according to any one of the preceding aspects, the post includes a second wear plate that opposes the wear plate. The second sidewall includes a second notch which corresponds to the second wear plate when the second wall is insertably received by the first channel and the second channel.

In an aspect, according to any one of the preceding aspects, the masking system includes a fourth piece having a notch configured to interface with a rim of the disc.

In an aspect, according to any one of the preceding aspects, the disc is a fan disc of a gas turbine.

In an aspect, according to any one of the preceding aspects, the masking system includes a first piece, a second piece having a first channel and a second channel, and a third piece having a first wall, a second wall, a first sidewall, and a second sidewall. The first sidewall has a first notch. The first piece is configured to be connected to the second piece. The second wall of the third piece is configured to be insertably received by the first channel and the second channel such that a portion of the component is accessible via the first notch.

In an aspect, according to any one of the preceding aspects, the first piece has a frusto-rectangular groove and the second piece has a frusto-rectangular projection.

In an aspect, according to any one of the preceding aspects, the first piece and the second piece are connected in an end-to-end configuration.

In an aspect, according to any one of the preceding aspects, each of the first piece, the second piece, and the third piece is additively manufactured using a high-temperature material.

### BRIEF DESCRIPTION OF THE DRAWINGS

Illustrative embodiments of the present disclosure are described in detail below with reference to the attached drawing figures and wherein:

FIG. 1 is a schematic view of a gas turbine engine, according to some aspects of the disclosure.

FIG. 2 is a perspective view of a fan blade, according to some aspects of the disclosure.

FIG. 3 is a front view of a fan disc with a plurality of fan blades attached thereto, according to some aspects of the disclosure.

FIG. 4A is a perspective view of a fan disc of a gas turbine engine, according to some aspects of the disclosure.

FIG. 4B is a detailed view of a portion of the fan disc of FIG. 4A.

FIG. 5A is another detailed view of a portion of the fan disc of FIG. 4A showing posts having undamaged wear plates, according to some aspects of the disclosure.

FIG. 5B is another detailed view of the portion of the fan disc in FIG. 5A showing posts having damaged wear plates, according to some aspects of the disclosure.

FIG. 6 is another detailed view of the portion of the fan disc in FIG. 5B illustrating the portion being masked using masking tape, according to some aspects of the

FIG. 7A is a perspective view of a masking system, according to some aspects of the disclosure.

FIG. 7B is an exploded view of the masking system of FIG. 7A, according to some aspects of the disclosure.

FIG. 8A is a perspective view of a first piece of the masking system of FIG. 7A, according to some aspects of the disclosure.

FIG. 8B is a front view of the first piece of FIG. 8A, according to some aspects of the disclosure.

FIGS. 9A-9B are perspective views of a second piece of the masking system of FIG. 7A, according to some aspects of the disclosure.

FIGS. 10A-10D are perspective views of a third piece of the masking system of FIG. 7A, according to some aspects of the disclosure.

FIG. 11A is a perspective view of a fourth piece of the masking system of FIG. 7A, according to some aspects of the disclosure.

FIG. 11B is a side view of the fourth piece of the masking system of FIG. 7A, according to some aspects of the disclosure.

FIGS. 12A-12B are perspective views illustrating the connection between the first piece and the second piece, according to some aspects of the disclosure.

FIGS. 12C-12D are side views illustrating the connection between the first piece and the second piece, according to some aspects of the disclosure.

FIGS. 13A-13D are perspective views illustrating the connection between the third piece and the second piece, according to some aspects of the disclosure.

FIG. 14 is a perspective view illustrating the second piece operatively arranged on a damaged fan disc, according to some aspects of the disclosure.

FIGS. 15A and 15B are perspective views illustrating the first piece and the second piece operatively arranged on the damaged fan disc, according to some aspects of the disclosure.

FIGS. 16A and 16B are perspective views illustrating the first piece, the second piece, and the third piece operatively arranged on the damaged fan disc, according to some aspects of the disclosure.

FIG. 17 is a perspective view illustrating the first piece, the second piece, the third piece, and the fourth piece of one masking system operatively arranged on the damaged fan disc, according to some aspects of the disclosure.

FIG. 18 is a perspective view illustrating a plurality of masking systems of FIG. 7A selectively masking a damaged fan disc, according to some aspects of the disclosure.

FIG. 19A is another perspective view illustrating a plurality of masking systems of FIG. 7A selectively masking a damaged fan disc, according to some aspects of the disclosure.

FIG. 19B is a detailed view of a portion of the damaged fan disc of FIG. 19A.

FIG. 20A is another perspective view illustrating a plurality of masking systems of FIG. 7A selectively masking a damaged fan disc, according to some aspects of the disclosure.

FIG. 20B is a detailed view of a portion of the damaged fan disc of FIG. 20A.

FIGS. 21A and 21B are perspective views showing the masking systems of FIG. 7A selectively masking the damaged fan disc while the wear plates thereof are repaired, according to some aspects of the disclosure.

### DETAILED DESCRIPTION

A gas turbine engine typically includes a multi-stage compressor coupled to a multi-stage turbine via an axial shaft. The multi-stage compressor may include a low-pressure compressor and a high-pressure compressor, and the multi-stage turbine may include a low-pressure turbine and a high-pressure turbine. Air enters the gas turbine engine through the low-pressure compressor where its temperature and pressure are increased as it passes through subsequent stages of the compressor. The compressed air is then directed to one or more combustors where it is mixed with a fuel source to create a combustible mixture. This mixture is ignited in the combustors to create a flow of hot combustion gases. These gases are directed into the turbine causing the turbine to rotate, thereby driving the compressor. The output of the gas turbine engine can be mechanical thrust via exhaust from the turbine or shaft power from the rotation of an axial shaft, where the axial shaft can drive a generator to produce electricity.

The compressor and turbine each include a plurality of rotating blades and stationary vanes having an airfoil extending into the flow of compressed air or flow of hot combustion gases. Each blade or vane has a particular set of design criteria which must be met to provide the necessary work to the flow passing through the compressor and the turbine. However, due to the severe nature of the operating environment, especially in the turbine, it is often necessary to cool these blades and vanes. The blades and vanes often utilize complex internal cooling passageways in order to maximize the efficiency of cooling fluid passing therethrough.

Gas turbine engines also include a fan that may be disposed at the front of the engine. The fan may include a disc to which a plurality of fan blades are coupled. The fan may rotate to increase the amount of air moving through the engine, and therefore increase the engine's thrust. The size of the fan blades may be greater than the size of the compressor blades and the turbine blades.

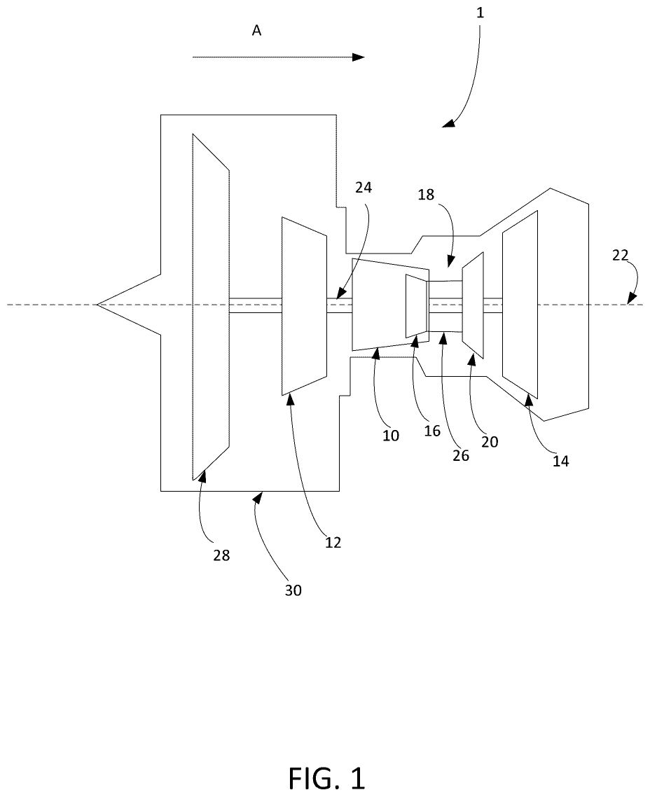

FIG. 1 schematically illustrates a gas turbine engine 1. The gas turbine engine 1 includes a generator 10, a low-pressure compressor 12, a low-pressure turbine 14, a high-pressure compressor 16, a combustion chamber 18, and a high-pressure turbine 20. Gases may flow into the gas turbine engine 1 in direction A, which may be parallel to a longitudinal axis 22 of the gas turbine engine 1. The low-pressure compressor 12 and low-pressure turbine 14 may be operably connected by low-pressure shaft 24 centered on longitudinal axis 22. Similarly, the high-pressure compressor 16 and the high-pressure turbine 20 may be operably connected via a high-pressure shaft 26 centered on longitudinal axis 22. The high-pressure shaft 26 may be arranged around the low-pressure shaft 24. The gas turbine engine 1 may also include a fan 28 that may be encased in a fan casing 30. The fan 28 may be disposed upstream the low-pressure compressor 12, and may include a plurality of fan blades 40 that rotate about longitudinal axis 22. Fan 28, in some examples, may be movably coupled to low-pressure shaft 24 and driven by the low-pressure turbine 14.

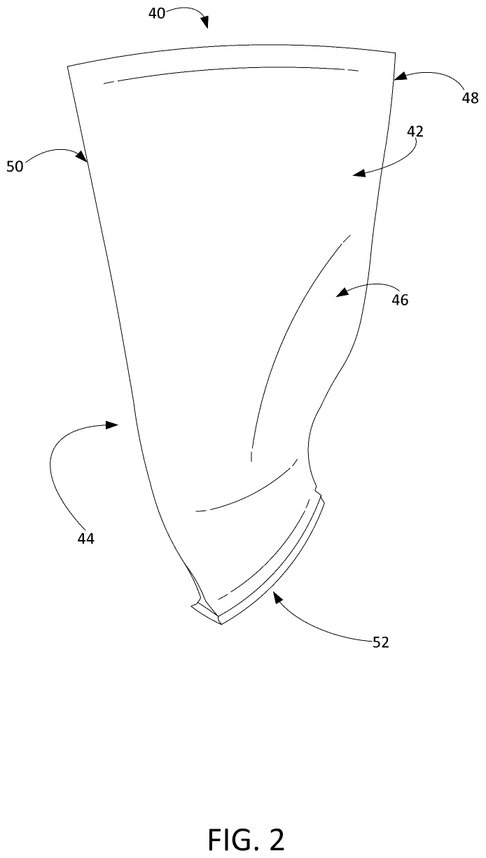

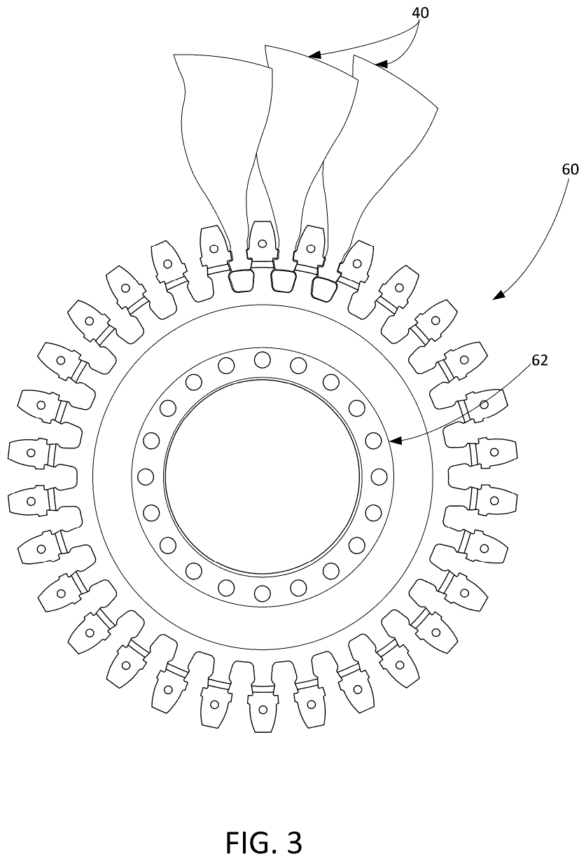

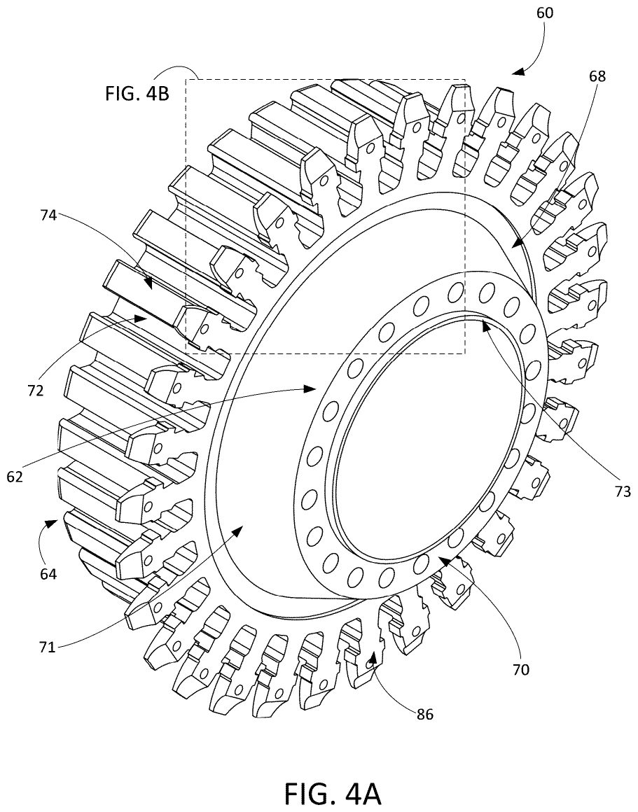

FIG. 2 shows a fan blade 40. Fan blade 40 may be one of a plurality of fan blades of fan 28 of FIG. 1, or one of a plurality of fan blades of another gas turbine engine fan. The fan blade 40 includes an airfoil 42, which has a pressure surface 44 (not clearly visible in FIG. 2) and a suction surface 46. The pressure surface 44 and suction surface 46 each extend from leading edge 48 to trailing edge 50 of airfoil 42. The fan blade 40 may, at a lowermost section thereof, include a root portion or dovetail (hereinafter “root portion 52”). The root portion 52 may have a generally firtree shape. As discussed herein, root portion 52 may be located in a corresponding slot of a fan disc to operably couple the fan blade 40 to the fan disc.

FIG. 3 shows an example fan disc 60 with a plurality of fan blades 40 radially attached thereto, according to an example of the embodiments. Fan disc 60 may be movably (e.g., rotatably) coupled to low-pressure shaft 24 (see FIG. 1) of a gas turbine engine 1 and may be driven by the low-pressure turbine 14. In other examples, fan disc 60 may be operably coupled to one or more components of another gas turbine engine.

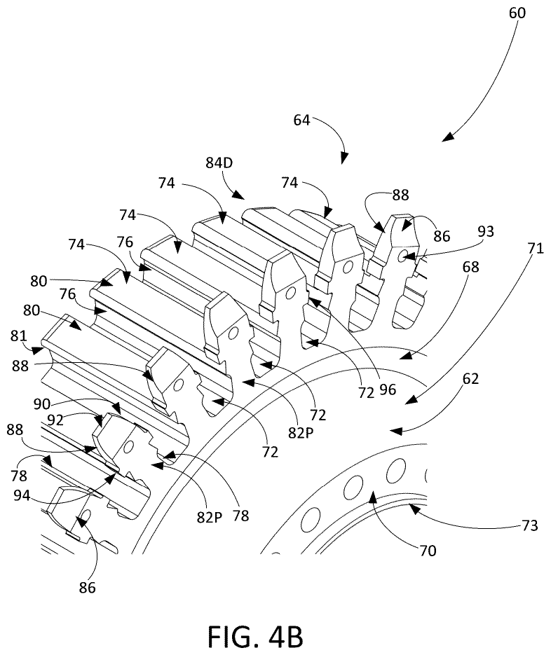

FIGS. 4A and 4B show fan disc 60 (without fan blades 40 attached thereto) in more detail. In some examples, the fan disc 60 includes a flanged portion 62 and a mounting portion 64 adjacent the flanged portion 62. Flanged portion 62 and mounting portion 64 may be of unitary construction, or flanged portion 62 may be coupled to mounting portion 64 using fasteners, weld joints, or one or more other suitable fastening techniques. When fan disc 60 is operably coupled to low-pressure shaft 24 (see FIG. 1) of gas turbine engine 1, mounting portion 64 may be upstream the flanged portion 62.

Flanged portion 62 may be generally stairstep or Z-shaped and include a first wall 68, a second wall 70, and a connecting wall 71. First wall 68 and second wall 70 of flanged portion 62 may each extend generally vertically (see FIG. 4A), and connecting wall 71 may extend upwards at an angle (e.g., an acute angle) from first wall 68 to second wall 70. First wall 68 of flanged portion 62 of fan disc 60 may, in some examples, be adjacent mounting portion 64 of fan disc 60. When fan disc 60 is operably coupled to low-pressure shaft 24 (see FIG. 1) as part of fan 28 of gas turbine engine 1, second wall 70 may be proximate low-pressure turbine 14 relative to first wall 68. In some examples, flanged portion 62 may include a rim 73 (see FIG. 4A) that is adjacent second wall 70 and extends away from mounting portion 64.

Mounting portion 64 of fan disc 60 may be configured to mountingly receive a plurality of fan blades 40, e.g., the root portions 52 thereof, or root portions or dovetails of other fan blades. In an example of the embodiments, mounting portion 64 of fan disc 60 may include an alternating arrangement of slots 72 and stops 74 disposed circumferentially around the mounting portion 64. One slot 72 may be generally identical to another slot 72, and one stop 74 may be generally identical to another stop 74. Each slot 72 and each stop 74 may extend axially along the width of mounting portion 64 (see FIG. 4B). Each slot 72 may be defined at least in part by the axially-extending stop 74 adjacent that slot 72 in the counterclockwise direction, and the axially-extending stop 74 adjacent that slot 72 in a clockwise direction.

In some examples, each stop 74 may include a first sidewall 76, a second sidewall 78, a top wall 80, a proximal end 82P, and a distal end 84D (see FIG. 4B). The first sidewall 76 may oppose the second sidewall 78, and the proximal end 82P may oppose the distal end 84D. In some examples, proximal end 82P of each stop 74 may be proximate the flanged portion 62 relative to the distal end 84D thereof. Each of the first sidewall 76 and the second sidewall 78 of each stop 74 may be spaced apart from each other, and each may extend axially along the width of the mounting portion 64 from the proximal end 82P of that stop 74 to the distal end 84D of that stop 74. In some examples, the first sidewall 76 of each stop 74 may be counterclockwise to the second sidewall 78 of that stop 74, and each of the first sidewall 76 and second sidewall 78 may extend axially and be generally parallel to each other. The top wall 80 may extend axially from the distal end 84D towards the proximal end 82P atop each of the first sidewall 76 and the second sidewall 78. In some examples, the top wall 80 may have an overhanging portion 81 (see FIG. 4B) that extends beyond the first sidewall 76 and the second sidewall 78 at the distal end 84D.

Each slot 72 may be defined at least in part by the second sidewall 78 of one stop 74 and the first sidewall 76 of another stop 74. More specifically, each slot 72 may be defined at least in part by the second sidewall 78 of the stop 74 adjacent that slot 72 in a counterclockwise direction, and by the first sidewall 76 of the stop 74 adjacent that slot 72 in a clockwise direction. Each of the first sidewall 76 and the second sidewall 78 of each stop 74 may have a firtree shape that generally corresponds to the root portion 52 of a respective fan blade 40 (see FIG. 2). Each slot 72 may therefore be configured to receive and retain fan blade 40, and specifically, root portion 52 thereof. For example, root portion 52 of each fan blade 40 may be slid axially into and mountingly coupled to one of the slots 72 such that each slot 72 receives and retains one fan blade 40. While not clearly shown in the figures for clarity, when the root portion 52 of each fan blade 40 is so inserted into a corresponding slot 72, the leading edge 48 (see FIG. 2) of the respective fan blade 40 may be proximate and between the distal end 84D of the stop 74 adjacent that slot 72 in a counterclockwise direction and the distal end 84D of the stop 74 adjacent that slot 72 in a clockwise direction. Similarly, the trailing edge 50 of a fan blade 40 retained by a particular slot 72 may be proximate and between the proximal end 82P of the stop 74 adjacent that slot 72 in a counterclockwise direction and the proximal end of the stop 74 adjacent that slot 72 in a clockwise direction.

One post 86 (see FIG. 4B) may extend from each stop 74 at or proximate the proximal end 82P of that stop 74. Each post 86 may extend radially outward from the top wall 80 of the respective stop 74. Each post 86 may include a first sidewall 88, a second sidewall 90, and a top wall 92. In some examples, each post 86 may have a generally frusto-triangular shape. In other examples, the posts 86 may be square, rectangular, triangular, or be formed in other regular or irregular shapes.

Each of the first sidewall 88 and the second sidewall 90 of each post 86 may extend radially outward from the top wall 80 of the respective stop 74. In some examples, first sidewall 88 of each post 86 may extend radially outwards from the top wall 80 of the respective stop 74 at or proximate first sidewall 76 of that stop 74, and the second sidewall 90 of that post 86 may extend radially outwards from the top wall 80 of that stop 74 at or proximate the second sidewall 78 of the stop 74. Each post 86 may include an aperture 93. Each aperture 93 may be configured for the passage of a fastener (not illustrated for clarity) therethrough, to allow the fan disc 60 to be rotatably secured to one or more other components of the gas turbine engine 1.

In some examples, each post 86 may include two wear plates, protrusions, or tabs (hereinafter “first wear plate 94” and “second wear plate 96”). The first wear plate 94 of each post 86 may oppose and extend away from the second wear plate 96 of that post 86. In an example of the disclosure, the first wear plate 94 may extend laterally from the first sidewall 88 of a respective post 86, and the second wear plate 96 may extend laterally from the second sidewall 90 of that post 86. More specifically, the first wear plate 94 of each post 86 may extend laterally above the nearest slot 72 counterclockwise to that post 86, and the second wear plate 96 of each post 86 may extend laterally above the nearest slot 72 clockwise to that post 86.

Once the root portion 52 of one fan blade 40 is received within each slot 72, each of the first wear plate 94 and the second wear plate 96 of each post 86 may contact the airfoil 42 of one fan blade 40. In some aspects of the embodiments, the first wear plate 94 of one post 86 may contact and push against one of the suction surface 46 and the pressure surface 44 of one fan blade 40 when the root portion 52 thereof is inserted into the nearest slot 72 counterclockwise to that post 86, and the second wear plate 96 of that post 86 may contact and push against the other of the suction surface 46 and the pressure surface 44 of another fan blade 40 when the root portion 52 thereof is inserted into the nearest slot 72 clockwise to that post 86. For example, the first wear plate 94 of a particular post 86 may contact and push against the suction surface 46 of one fan blade 40 when the root portion 52 of that fan blade 40 is inserted into the nearest slot 72 counterclockwise to that post 86, and the second wear plate 96 of that post 86 may contact and push against the pressure surface 44 of another fan blade 40 when the root portion 52 of that other fan blade 40 is inserted into the nearest slot 72 clockwise to that post 86. In an aspect of the embodiments, the suction surface 46 of a particular fan blade 40 may be engaged by the first wear plate 94 of a particular post 86, and the pressure surface 44 of that particular fan blade 40 may be engaged by the second wear plate 96 of post 86 counterclockwise to that particular post 86. Engagement, e.g., frictional engagement, of the first wear plates 94 and the second wear plates 96 of the posts 86 with the pressure surfaces 44 and suction surfaces 46 of the fan blades 40 may facilitate secure fitment of the fan blades 40 to the fan disc 60. That is, the airfoil 42 of each fan blade 40 may be in contact with and sandwiched between the first wear plate 94 of one post 86 and the second wear plate 96 of a neighboring post 86, which may preclude or minimize relative movement between the fan blade 40 and the slot 72 within which the root portion 52 that fan blade 40 is secured.

The fan disc 60 may rotate during operation of the gas turbine engine 1, e.g., be driven by the low-pressure turbine 14. Rotation of the fan disc 60 may cause the fan blades 40 secured thereto to also rotate. The angular velocity of the fan disc 60, and therefore the angular velocity of the fan blades 40 mounted thereto, may increase or decrease unevenly during operation of the gas turbine engine 1 (e.g., angular velocity of the fan disc 60 may increase or decrease to respectively speed up or slow down an aircraft powered by one or more gas turbine engines 1). Angular acceleration and deceleration of the fan blades 40 may cause the airfoils 42 of fan blades 40 to exert variable forces on the first wear plate 94 and/or the second wear plate 96 in contact with these airfoils 42. These forces applied by the airfoils 42 to the first wear plate 94 and the second wear plate 96 may, over time, damage or erode one or more of the first wear plate 94 and the second wear plate 96 of one or more of the posts 86.

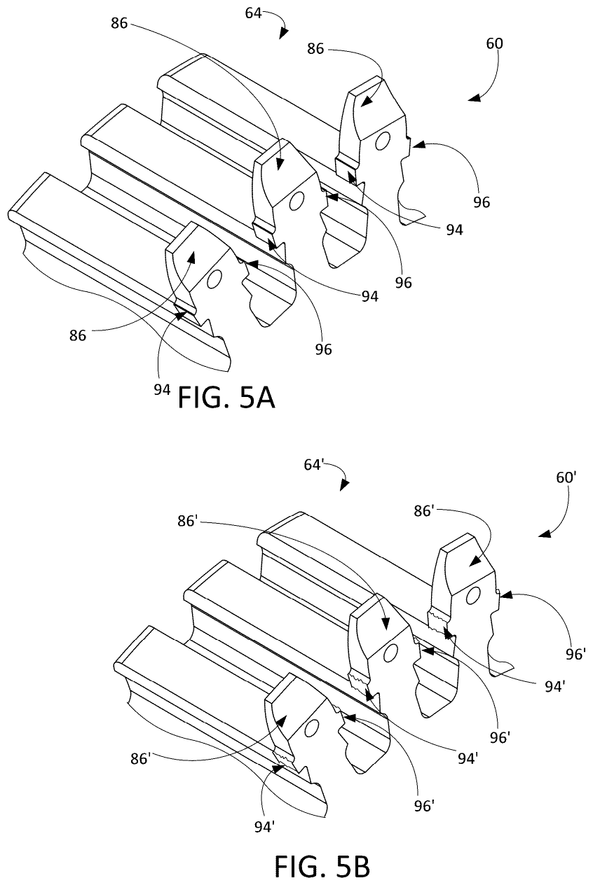

To illustrate, compare, e.g., FIG. 5A with FIG. 5B. FIG. 5A illustrates a part of the mounting portion 64 of fan disc 60, and FIG. 5B illustrates a part of mounting portion 64′ of a damaged fan disc 60′. The fan disc 60 and damaged fan disc 60′ are identical, except that posts 86 of mounting portion 64 of fan disc 60 have first wear plates 94 and second wear plates 96 that are unworn, whereas posts 86′ of mounting portion 64′ of damaged fan disc 60′ have first wear plates 94′ and second wear plates 96′ that have eroded, for example eroded over time due to the interaction of the wear plates with the fan blades 40. The erosion of one or more of the first wear plate 94 and the second wear plate 96 of one or more posts 86 may weaken the attachment of the fan blades 40 to the fan disc 60, and consequently, degrade operation of the fan 28. It may be desirable to repair the damaged fan disc 60′, and specifically the damaged first wear plates 94′ and/or the damaged second wear plates 96′ of posts 86′ thereof, to facilitate suitable operation of the fan 28.

In the example illustrated in FIG. 5B, portions of fan disc 60′ that have incurred damage are the first wear plates 94′ and the second wear plates 96′ of the posts 86′. In some examples, to repair the first wear plates 94′ and/or the second wear plates 96′, the remainder of the fan disc 60′ may be selectively masked so as to leave exposed only those areas of the fan disc 60′ that are in need of repair. That is, the first wear plates 94′ and second wear plates 96′ of the mounting portion 64′ may be left exposed while the remainder of the fan disc 60′ may be masked generally in its entirety. Leaving the first wear plates 94′ and the second wear plates 96′ exposed may allow these first wear plates 94′ and second wear plates 96′ to be accessed for repair. For example, the surfaces of the exposed first wear plates 94′ and second wear plates 96′ may be blasted with abrasive media and then repaired using a thermal spray process and/or one or more other suitable repair processes.

Tape, e.g., heat-resistant tape, may be used to selectively mask the damaged fan disc 60′. For example, areas of the damaged fan disc 60′ proximate the first wear plates 94′ and second wear plates 96′, and other areas of the damaged fan disc 60′ that have a likelihood of being impacted inadvertently during repair of the first wear plates 94′ and second wear plates 96′, may be masked with heat-resistant tape. In some examples, apart from first wear plates 94′ and second wear plates 96′, a majority of the components of the damaged fan disc 60′ may be masked with heat-resistant tape to minimize the likelihood of damage to these components during repair of the first wear plates 94′ and second wear plates 96′.

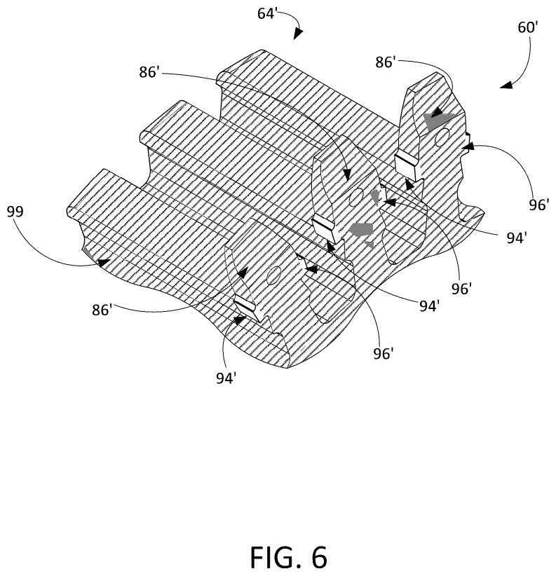

FIG. 6 illustrates a portion of a damaged fan disc 60′ that has been selectively masked using heat-resistant tape 99 (shading in FIG. 6 indicates those areas of the portion of the damaged fan disc 60′ that are masked with heat-resistant tape 99). In the example illustrated in FIG. 6, the first wear plates 94′ and the second wear plates 96′ are exposed whereas the remainder of the damaged fan disc 60′ is masked with heat-resistant tape 99. Selectively taping the damaged fan disc 60′ with the heat-resistant tape 99 may ensure that the repair processes (e.g., abrasive blasting and thermal spray processes) do not impact those portions of the fan disc 60′ (e.g., flanged portion 62, the first sidewall 76, second sidewall 78, and top wall 80 of each stop 74, et cetera) that are not in need of repair.

The damaged fan disc 60′ may be relatively large, e.g., may have a diameter of 5 feet or more. Taping large portions of the damaged fan disc 60′ may be time-consuming, laborious, and expensive. The heat-resistant tape 99 may only come in certain standard sizes, and an operator may be required to cut the heat-resistant tape 99 into custom shapes to ensure that the heat-resistant tape 99 selectively masks those areas of the damaged fan disc 60′ that may otherwise be unintentionally damaged during repair of the first wear plates 94′ and the second wear plates 96′. Further, it may be necessary to cut the heat-resistant tape 99 into the custom shapes prior to application of heat-resistant tape 99 to the damaged fan disc 60′, as cutting the heat-resistant tape 99 after it has been applied to the damaged fan disc 60′ may scratch or otherwise damage one or more surfaces of the fan disc 60′. In view of these considerations, it may take several hours to selectively tape large portions of the relatively large fan disc 60′ such that the first wear plates 94′ and the second wear plates 96′ thereof are left exposed. Once the repair is complete, the heat-resistant tape 99 may have to be laboriously disassociated from the fan disc 60′. And further yet, the heat-resistant tape 99—which is generally expensive—may be a consumable item and may have to be discarded after a single use. It is not unusual for facilities that repair fan discs to spend hundreds of thousands of U.S. dollars on heat-resistant tape alone.

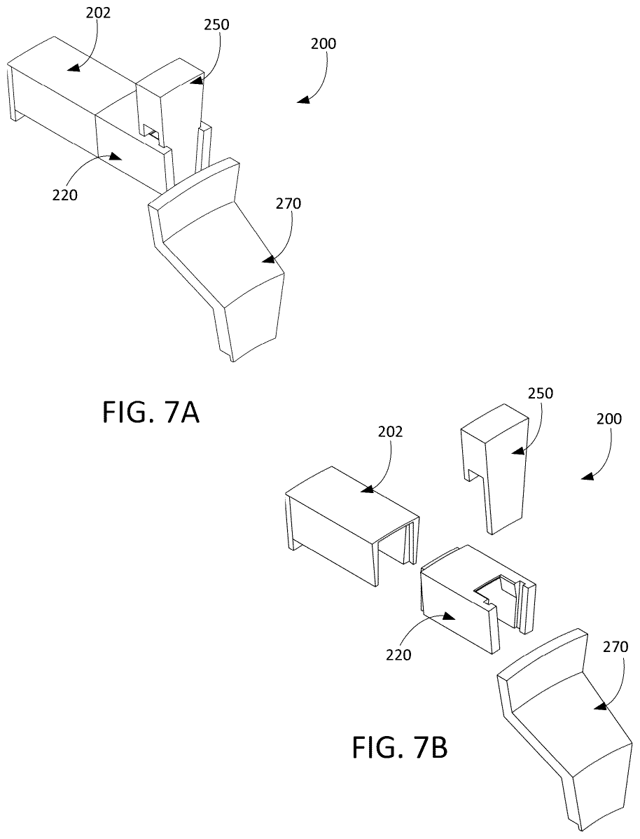

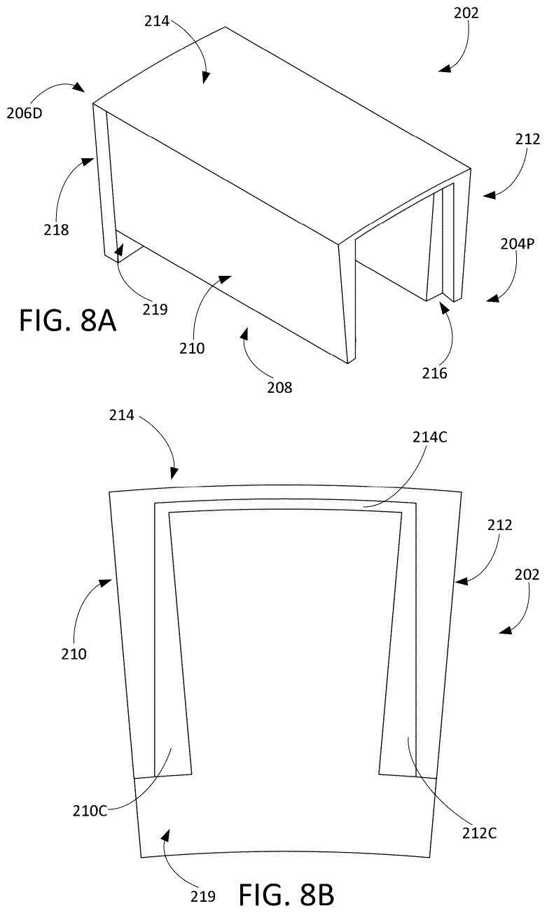

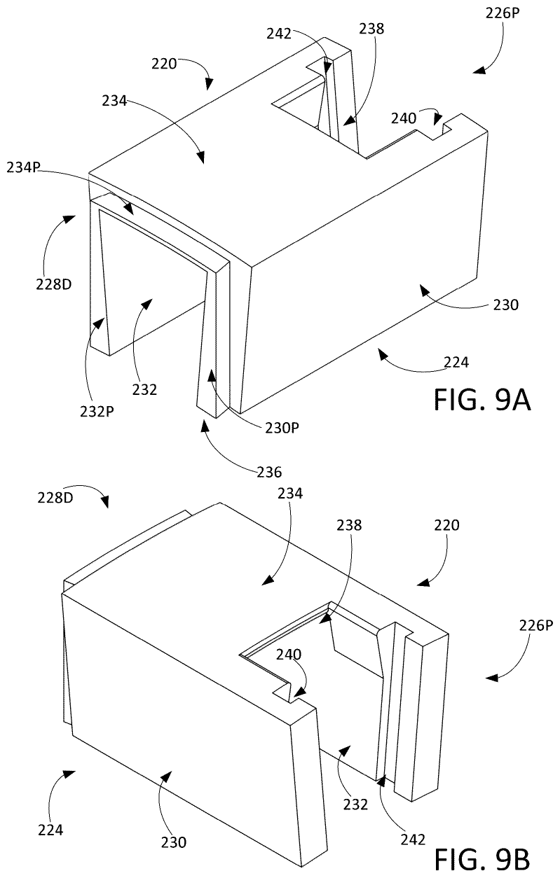

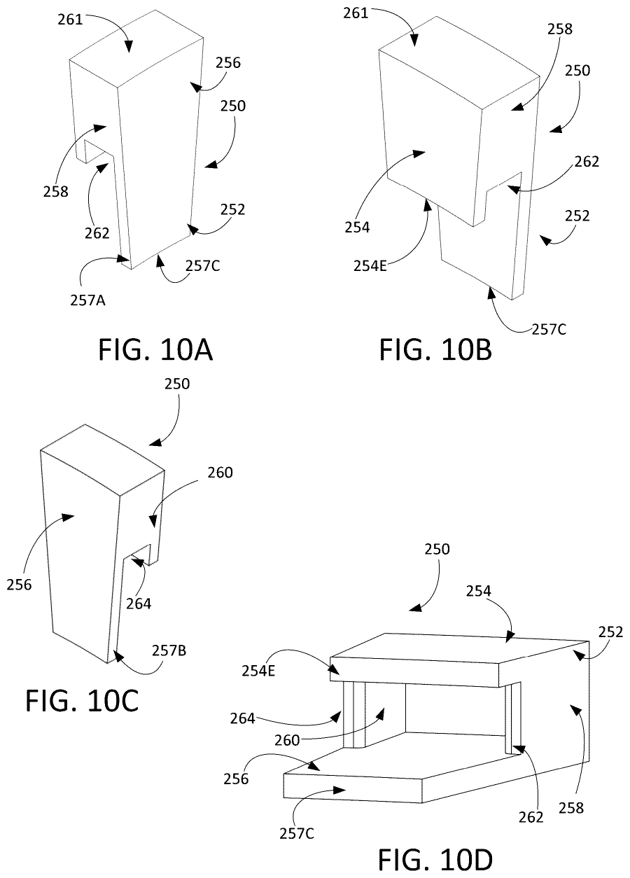

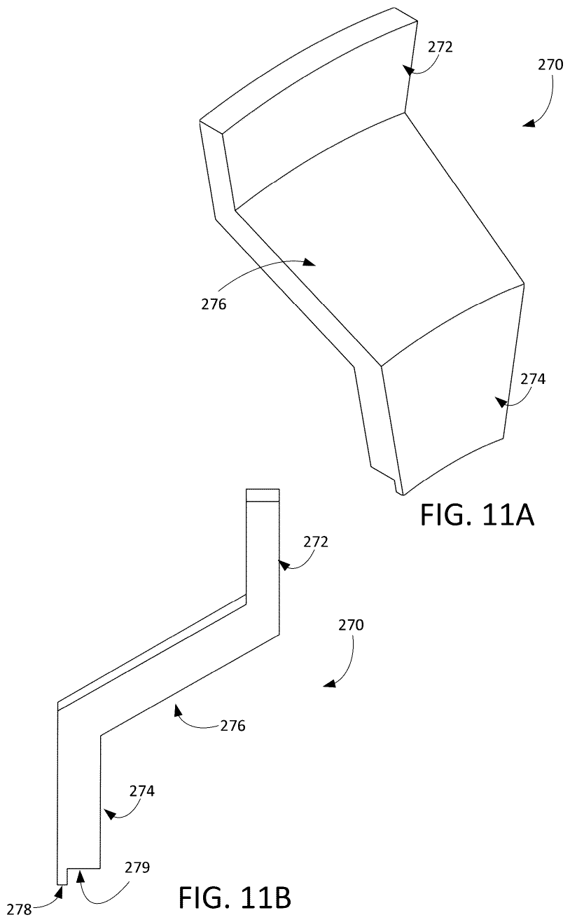

FIGS. 7A-7B show a masking system 200, according to one aspect of the disclosure. The masking system 200 may also be referred to herein as an interlocking masking system (hereinafter “masking system 200”). In some aspects of the embodiments, masking system 200 may include a first piece 202 (shown in more detail in FIGS. 8A-8B), a second piece 220 (shown in more detail in FIGS. 9A-9B), a third piece 250 (shown in more detail in FIGS. 10A-10D), and a fourth piece 270 (shown in more detail in FIGS. 11A-11B). In some examples, each of the first piece 202, the second piece 220, the third piece 250, and the fourth piece 270 may be disparate from each other, and each may have a unitary construction. As discussed herein, a plurality of masking systems 200 may be configured to collectively and selectively mask the damaged fan disc 60′ such that first wear plates 94′ and second wear plates 96′ of each post 86′ are exposed and accessible for repair. In some examples of the embodiments, fourth piece 270 may be omitted and masking system 200 may include first piece 202, second piece 220, and third piece 250.

FIG. 8A shows a perspective view of the first piece 202 and FIG. 8B shows a front view of the first piece 202. The first piece 202 may extend from a proximal end 204P to a distal end 206D. In some examples, the first piece 202 may include a body 208. In an aspect of the embodiments, the body 208 may be generally U-shaped. In other aspects of the embodiments, the body 208 may have a rectangular, triangular, cylindrical, or other symmetrical or asymmetrical shape.

The body 208 may have a first wall 210, a second wall 212, and a top wall 214. First wall 210 may oppose second wall 212, and each of first wall 210 and second wall 212 may extend generally perpendicularly from opposing ends of top wall 214. First wall 210 and second wall 212 may have the same or about the same height and width. At the distal end 206D, a rear wall 218 may extend from the top wall 214. The rear wall 218 and the top wall 214 may have the same or about the same width, and the height of the rear wall 218 may be greater than the height of the first wall 210 and the second wall 212. The rear wall 218 may therefore have an extended portion 219 that extends beneath the first wall 210 and second wall 212.

In some examples, each of the first wall 210, the second wall 212, and the top wall 214 may, at the proximal end 204P of the first piece 202, include a respective cutback 210C, 212C, and 214C. The cutbacks 210C, 212C, and 214C may collectively form a continuous three-sided or frusto-rectangular groove 216.

FIGS. 9A and 9B show second piece 220 of the masking system 200 in more detail. Second piece 220 may have a body 224 that extends from a proximal end 226P to a distal end 228D of the second piece 220. In some examples, body 224 of second piece 220 may be generally U-shaped, though in other examples, body 224 may be rectangular, cylindrical, or be formed in other symmetrical or asymmetrical shapes. Body 224 may include a first wall 230, a second wall 232, and a top wall 234. First wall 230 and second wall 232 may oppose each other and extend generally perpendicularly from opposing ends of the top wall 234.

Body 224 of second piece 220, at the distal end 228D, may include a projection 236. The projection 236 may be continuous, and may be three-sided or frusto-rectangular. For example, the projection 236 may be formed collectively by a protrusion 230P protruding from first wall 230, a protrusion 232P protruding from second wall 232, and a protrusion 234P protruding from top wall 234.

First wall 230, at an interior surface thereof, may include a first channel 240 (FIGS. 9A-9B) that extends generally vertically. Second wall 232, at an interior surface thereof, may likewise include a second channel 242 that extends generally vertically and faces first channel 240. In some examples, first channel 240 and second channel 242 are proximate to proximal end 226P relative to distal end 228D. A cutout 238 may be formed in the top wall 234 at the proximal end 226P. First channel 240 and second channel 242 may be accessed through cutout 238 in top wall 234.

FIGS. 10A-10D show third piece 250 of masking system 200 in more detail. The third piece 250 may have a body 252. In some examples, the body 252 may have a squared-hook shape. In other embodiments, the body 252 may have a rectangular, triangular, cylindrical, or other symmetrical or asymmetrical shape.

The body 252 of third piece 250 may, in some examples, have a first wall 254, a second wall 256, a first sidewall 258, a second sidewall 260, and a top wall 261. First wall 254 may oppose second wall 256, and first sidewall 258 may oppose second sidewall 260. First wall 254 may have a bottom end 254E. Second wall 256 may have a bottom end 257C, a first edge 257A, and a second opposing edge 257B. In some examples, a height of second wall 256 may be greater than a height of first wall 254, i.e., bottom end 257C of second wall 256 may extend below bottom end 254E of first wall 254.

First sidewall 258 and second sidewall 260 may be spaced apart and may extend from first wall 254 to second wall 256. In an aspect of the embodiments, first sidewall 258 may have a first notch 262, and second sidewall 260 may have a second notch 264. The first notch 262 may oppose the second notch 264. In some examples, each of the first notch 262 and the second notch 264 may be generally frusto-rectangular. In other examples, first notch 262 and/or second notch 264 may be rectangular, spherical, or be formed in other symmetrical or asymmetrical shapes.

FIGS. 11A-11B show fourth piece 270 of masking system 200 in more detail. As noted, fourth piece 270 may be optional and may, in some examples, be omitted from masking system 200. Fourth piece 270 may be generally stairstep or Z-shaped. In an example, fourth piece 270 has a first wall 272, a second wall 274, and a connecting wall 276. First wall 272 and second wall 274 of fourth piece 270 may each extend generally vertically, and connecting wall 276 may extend upwards at an acute angle from first wall 272 to second wall 274. Second wall 274 may have a bottom end 278. In some examples, bottom end 278 may have an indentation 279 and be generally L-shaped. In other examples, the bottom end 278 may be rectangular, square, or be formed in other symmetrical or asymmetrical shapes.

One or more of the first piece 202, second piece 220, third piece 250, and fourth piece 270 of masking system 200 may (but need not) be configured to matingly or otherwise connect with another one or more of the first piece 202, second piece 220, third piece 250, and fourth piece 270. In an example, and as described herein, each of first piece 202 and third piece 250 may be configured to connect to second piece 220.

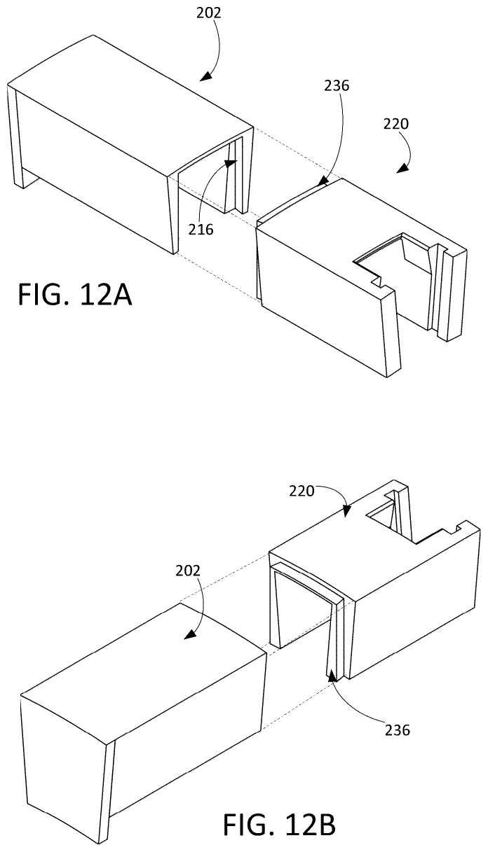

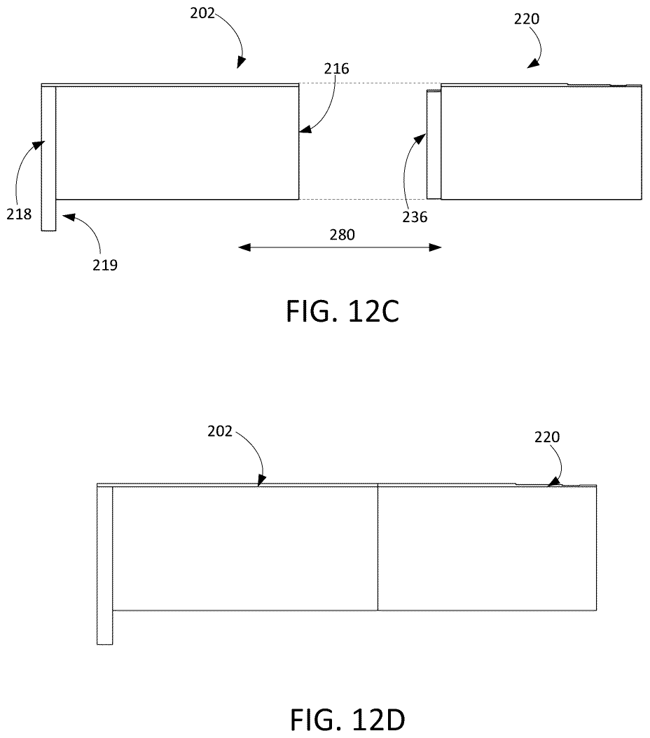

FIG. 7A shows first piece 202 connected to second piece 220. FIGS. 12A-12D show the connection of first piece 202 and second piece 220 in more detail. As described above with reference to FIGS. 8A-8B, first piece 202 may include groove 216 (e.g., a frusto-rectangular groove) at proximal end 204P. And, as discussed above with reference to FIGS. 9A-9B, second piece 220 may include a projection 236 (e.g., a frusto-rectangular projection) at distal end 228D. In some examples, groove 216 of first piece 202 may be sized and configured to receive projection 236 of second piece 220 to connect first piece 202 to second piece 220 (see FIGS. 12A-12D). For example, at least one of the first piece 202 and the second piece 220 may be pushed towards the other of the first piece 202 and the second piece 220 to cause the projection 236 of second piece 220 to be received by groove 216 of first piece 202. In one aspect of the embodiments, at least one of the first piece 202 and the second piece 220 may be pushed towards the other of the first piece 202 and the second piece 220 in a lateral direction 280 (see FIG. 12C) to connect the first piece 202 and the second piece 220 in an end-to-end configuration. FIG. 12D shows the first piece 202 and second piece 220 connected to each other. In some examples, the groove 216 may be undersized relative to projection 236 to have an interference fit between first piece 202 and second piece 220.

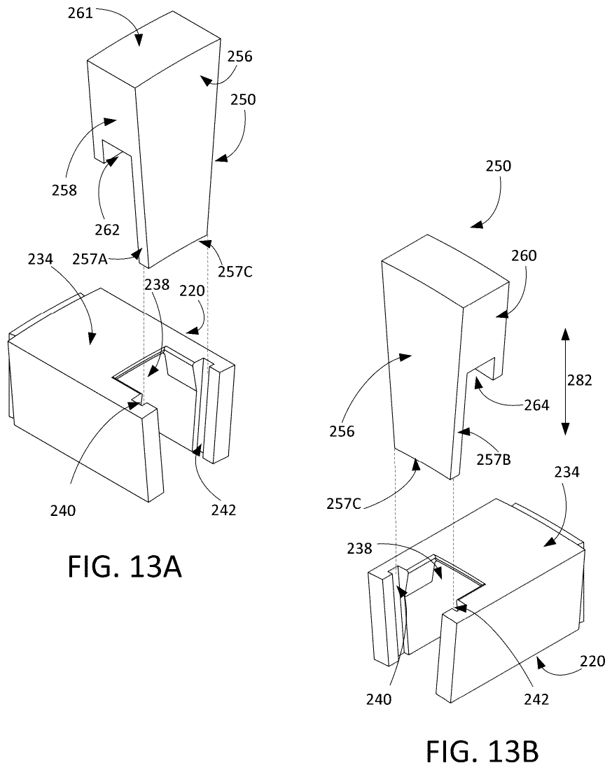

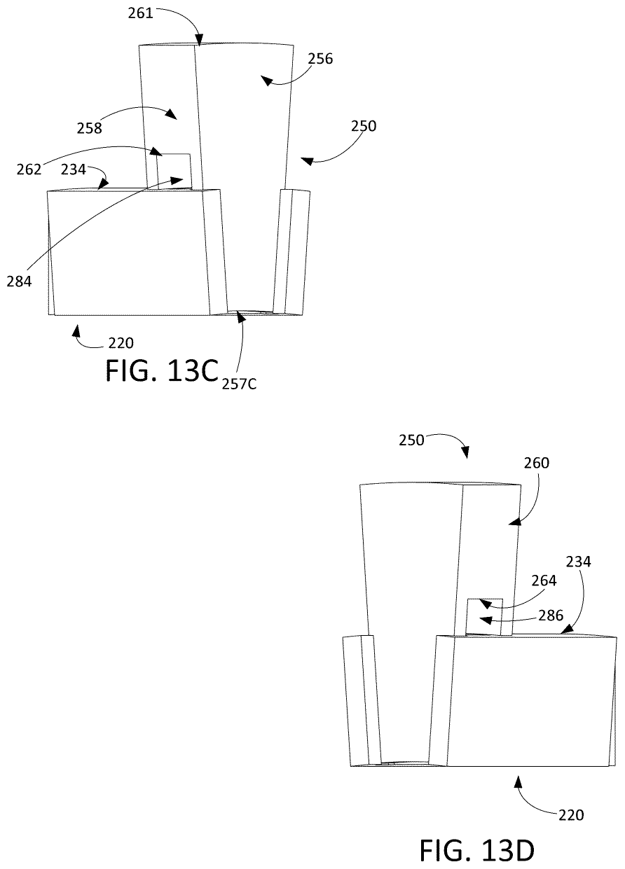

FIG. 7A further shows third piece 250 connected to second piece 220 while the first piece 202 is also connected to second piece 220. FIGS. 13A-13D show the connection between second piece 220 and third piece 250 in more detail. As described above with reference to FIGS. 9A-9B, second piece 220 may have first channel 240 and second channel 242 that may be accessible via cutout 238 in top wall 234. And as described above with reference to FIGS. 10A-10D, the first sidewall 258 and second sidewall 260 of third piece 250 may respectively include first notch 262 and second notch 264. In some examples, and as shown in FIGS. 13A and 13B, third piece 250 may be situated adjacent the second piece 220 such that second wall 256 of third piece 250 is adjacent cutout 238 in top wall 234 of second piece 220. Second wall 256 of third piece 250 may be insertably received by first channel 240 and second channel 242 of second piece 220. For example, second wall 256 of third piece 250 may be pushed downwards in a generally vertical direction 282 (FIG. 13B) through cutout 238 such that first edge 257A of second wall 256 of third piece 250 is received within first channel 240 of second piece 220 and second edge 257B of second wall 256 of third piece 250 is received within second channel 242 of second piece 220. Third piece 250 may thus lockingly engage second piece 220.

As noted, the height of second wall 256 of third piece 250 may be greater than the height of first wall 254 thereof. In an aspect of the embodiments, when the third piece 250 is lockingly connected to second piece 220 (see FIGS. 13C and 13D), bottom end 254E of first wall 254 of third piece 250 may rest atop top wall 234 of second piece 220 such that each of first notch 262 (see FIG. 13C) in first sidewall 258 of third piece 250 and second notch 264 (see FIG. 13D) in second sidewall 260 of third piece 250 are upwardly adjacent top wall 234 of second piece 220. A first window 284 (see FIG. 13C) may thus be formed by first notch 262 of first sidewall 258 of third piece 250 and top wall 234 of second piece 220. Similarly, a second window 286 (see FIG. 13D) may be formed by second notch 264 of second sidewall 260 of third piece 250 and top wall 234 of second piece 220. First window 284 and second window 286 will be described hereinafter with respect to function and masking.

Referring back to FIG. 7A, masking system 200 includes fourth piece 270. As discussed herein, each of first piece 202 and third piece 250 may matingly or otherwise connect with second piece 220. In an aspect of the embodiments, fourth piece 270 may not be configured to connect to any of the first piece 202, second piece 220, and third piece 250. In other aspects, however, fourth piece 270 may be configured to connect to one or more of first piece 202, second piece 220, and third piece 250.

As described herein, one or more masking systems 200 may be configured to selectively mask or cover one or more surfaces of damaged fan disc 60′-i.e., a fan disc 60 having a first wear plate 94 and/or a second wear plate 96 that has worn down over time (such as first wear plate 94′ and second wear plate 96′ of damaged fan disc 60′ illustrated in FIG. 5B). In some examples, a plurality of masking systems 200 may selectively mask all or part of each of the flanged portion 62 (see FIG. 4A) and the mounting portion 64′ of damaged fan disc 60′ such that first wear plate 94′ and second wear plate 96′ of each post 86′ are exposed. Such may allow for first wear plates 94′ and second wear plates 96′ of damaged fan disc 60′ to be repaired, e.g., allow first wear plate 94′ and second wear plate 96′ of each post 86′ (or of a subset of posts 86′) to be blasted with abrasive media and repaired using a thermal spray process, while eliminating or reducing the likelihood of damaging other portions of the damaged fan disc 60′ during the media blasting and/or thermal spraying processes.

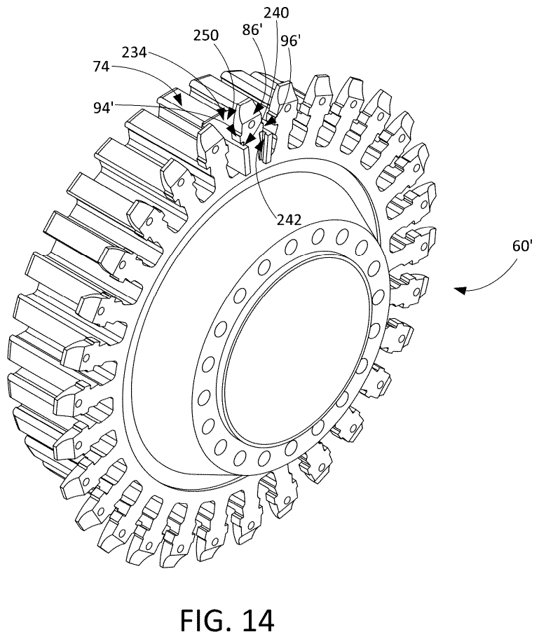

The manner of selectively masking the damaged fan disc 60′ using the masking system 200 is now described with reference to FIGS. 14 to 17. While FIGS. 14-17 show the components of the masking system 200 being arranged on the damaged fan disc 60′ in a particular order, the depicted order is not meant to be independently limiting. As described herein, a plurality of masking systems 200 may be required to selectively mask the damaged fan disc 60′ to allow the first wear plates 94′ and second wear plates 96′ to be repaired.

In some examples, and as shown in FIG. 14, one second piece 220 of one masking system 200 may be disposed on one stop 74 of the damaged fan disc 60′ such that post 86′ in contact with that stop 74 extends through cutout 238 (see FIG. 9A) in top wall 234 of second piece 220. When so configured, first wear plate 94′ of the post 86′ may be adjacent first channel 240 of second piece 220, second wear plate 96′ of that post 86′ may be adjacent second channel 242 of second piece 220, and each of the first wear plate 94′ and second wear plate 96′ may be above top wall 234 of second piece 220.

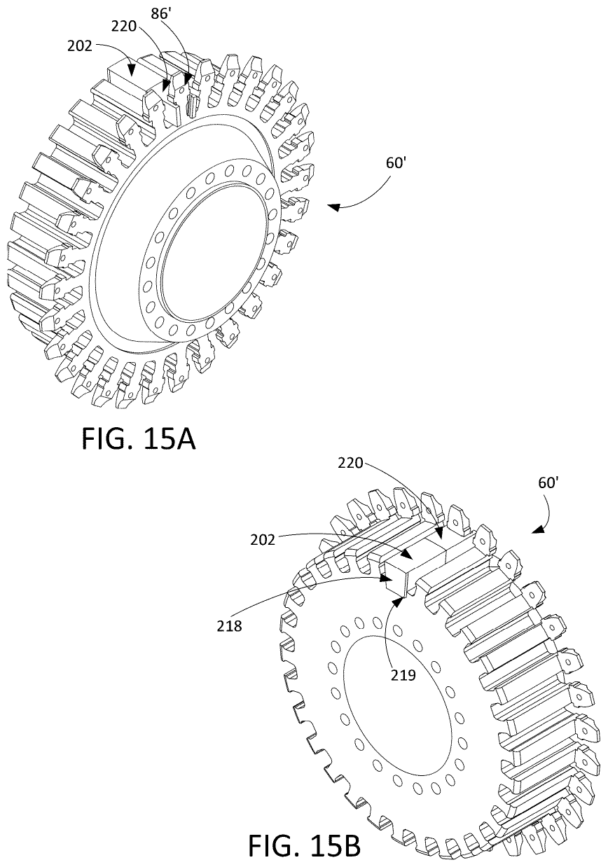

The manner of connecting first piece 202 and second piece 220 is discussed above, e.g., with reference to FIGS. 12A-12D. Once the second piece 220 is configured on the damaged fan disc 60′ as shown in FIG. 14, then, as shown in FIGS. 15A-15B, first piece 202 of masking system 200 may be disposed above the respective stop 74 (see FIG. 14) and connected to second piece 220 as described above with reference to FIGS. 12A-12D. When first piece 202 and second piece 220 are so connected above the respective stop 74, the extended portion 219 of rear wall 218 of first piece 202 (see FIGS. 8A-8B) may abut overhanging portion 81 (see FIG. 4B) of top wall 80 of the respective stop 74.

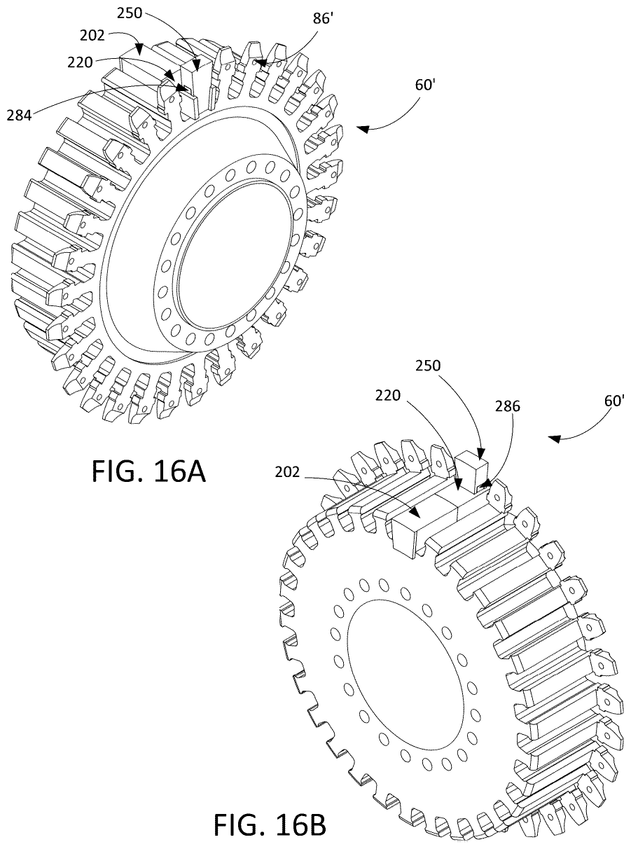

The manner of connecting third piece 250 to second piece 220 is discussed above, e.g., with reference to FIGS. 13A-13D. Once the second piece 220 is configured atop the stop as discussed above with reference to FIG. 14, and before or after the first piece 202 is connected to second piece 220 as discussed above with reference to FIGS. 15A-15B, the third piece 250 may be connected to second piece 220 as shown in FIGS. 16A-16B. When the third piece 250 is connected to second piece 220 in this fashion, third piece 250 may selectively mask the respective post 86′. More specifically, third piece 250 may selectively mask the respective post 86′ such that first window 284 (see also FIG. 13C) corresponds to first wear plate 94′ (see FIGS. 4B and 16A) and second window 286 corresponds to second wear plate 96′ (see FIGS. 4B and 16B). The first wear plate 94′ and the second wear plate 96′ may therefore be accessed for repair through first window 284 and second window 286, respectively, while the remainder of the stop 74 and post 86′ is (completely or at least partially) masked by the first piece 202, second piece 220, and third piece 250 of masking system 200.

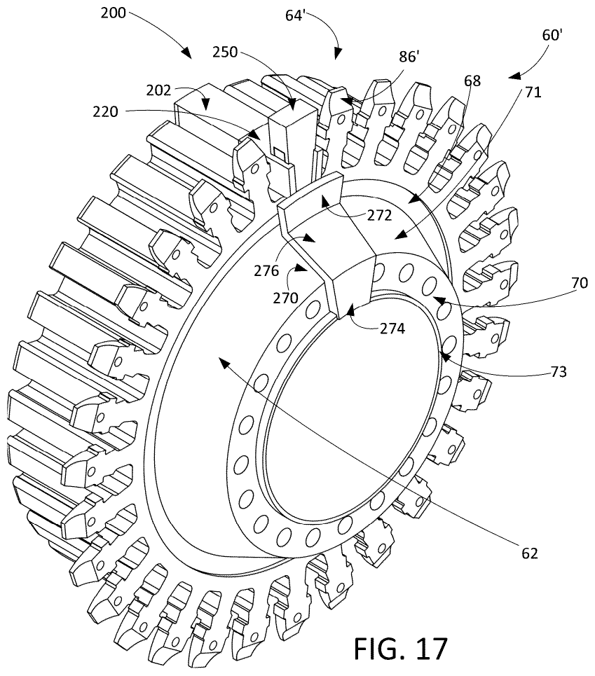

Each of first piece 202, second piece 220, and third piece 250 of masking system 200 may be configured to mask one or more surfaces of the mounting portion 64′ (see FIG. 5B) of the damaged fan disc 60′. In some examples of the embodiments, and as shown in FIG. 17, fourth piece 270 may be configured to mask the flanged portion 62 of the damaged fan disc 60′. Specifically, fourth piece 270 may be configured on the flanged portion 62 of the damaged fan disc 60′ such that the first wall 272 of fourth piece 270 is adjacent and masks at least a portion of first wall 68 of flanged portion 62, second wall 274 of fourth piece 270 is adjacent and masks at least a portion of second wall 70 of flanged portion 62, and connecting wall 276 of fourth piece 270 is adjacent and masks at least a portion of connecting wall 71 of flanged portion 62. The indentation 279 (see FIG. 11B) at bottom end 278 of second wall 274 may latch on to the rim 73 of the damaged fan disc 60′ to secure fourth piece 270 to damaged fan disc 60′.

As shown in FIG. 17, first piece 202, second piece 220, and third piece 250 of one masking system 200 may be used to selectively mask one stop 74 (see FIG. 4B) and one post 86′ (see FIG. 5B) of the damaged fan disc 60′. The damaged fan disc 60′ may have a plurality of stops 74 and posts 86′. In some examples of the embodiments, a plurality of masking systems 200 may be used to selectively mask the fan disc 60′ such that all the first wear plates 94′ and second wear plates 96′ of all the posts 86′ are exposed and accessible for repair.

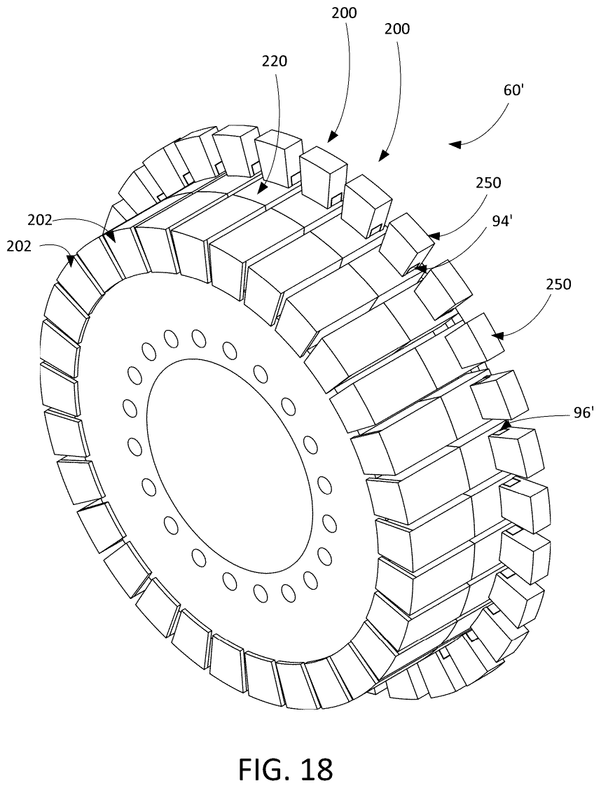

FIG. 18 shows a perspective view of a damaged fan disc 60′ (i.e., a fan disc 60′ including posts 86′ that have damaged first wear plates 94′ and second wear plates 96′) that is selectively masked in its entirety with a plurality of masking systems 200 such that all the first wear plates 94′ and second wear plates 96′ of all the posts 86′ are exposed (e.g., for repair). The fourth pieces 270 of the masking systems 200 are not visible in FIG. 18. As shown in FIG. 5B, damaged fan disc 60′ may have a plurality of posts 86′ (for example, between ten (10) posts 86′ and fifty (50) posts 86′). Therefore, a plurality of masking systems 200 may be used to selectively mask the damaged fan disc 60′ in its entirety.

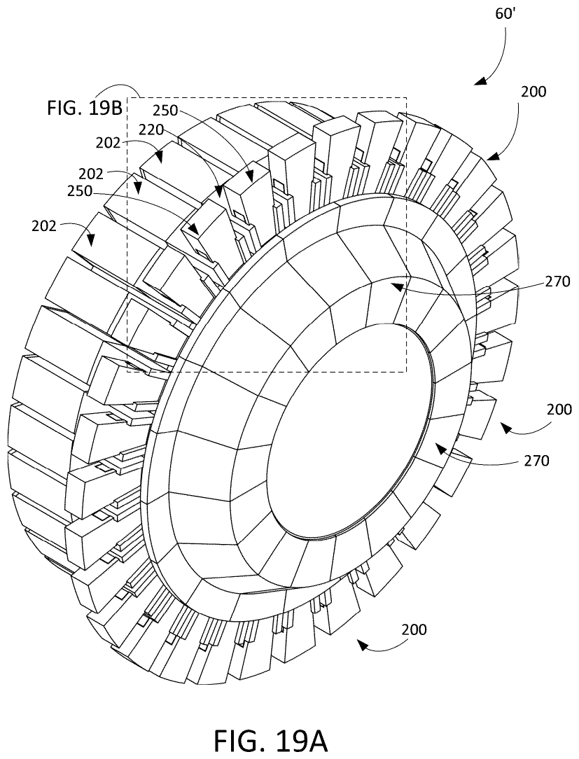

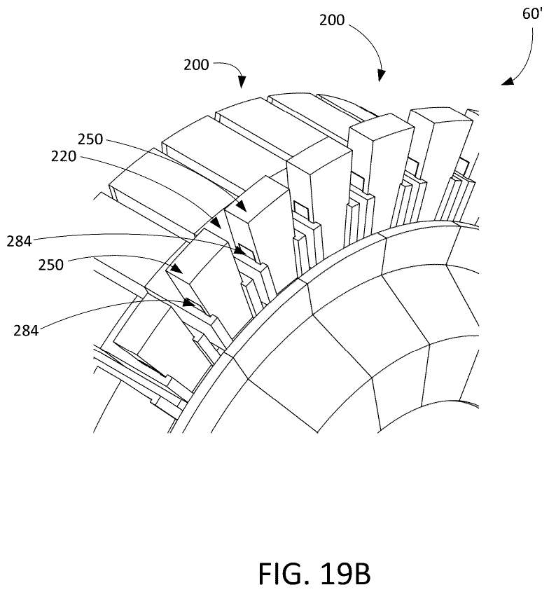

FIG. 19A is another perspective view illustrating a plurality of masking systems 200 selectively masking damaged fan disc 60′ in its entirety. As noted above, masking system 200 may but need not include fourth piece 270. For instance, in the example illustrated in FIG. 19A, the damaged fan disc 60′ has thirty (30) posts 86′. Therefore, thirty (30) sets, each including one first piece 202, one second piece 220, and one third piece 250, are shown in FIG. 19A—each set corresponding to one post 86′. However, in the example illustrated in FIG. 19A, only eighteen (18) fourth pieces 270 are needed to mask the flanged portion 62 (see FIG. 4A). Therefore, in some examples, fourth piece 270 may be omitted from masking system 200.

FIG. 19B is a detailed view of a portion of the damaged fan disc 60′ of FIG. 19A. As can be seen, each third piece 250 selectively masks a respective post 86′ such that first window 284 formed by that third piece 250 and the second piece 220 in contact with that third piece 250 leaves exposed the first wear plate 94′ (see FIGS. 4B and 16A) of that post 86′.

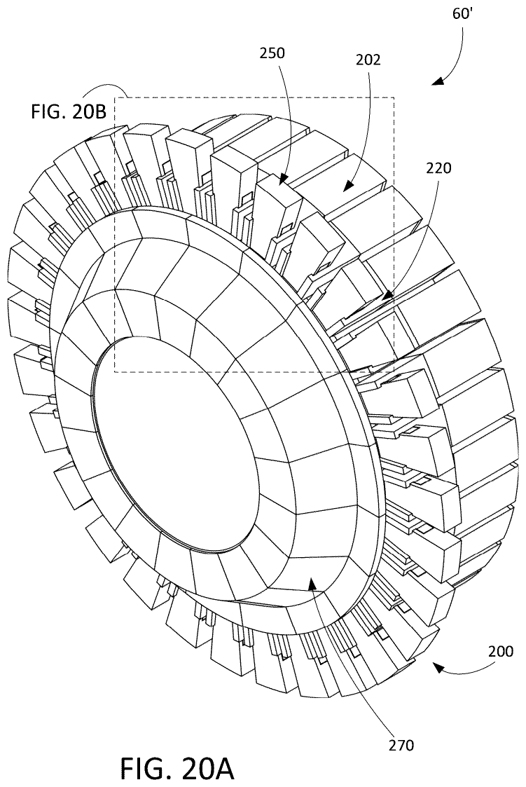

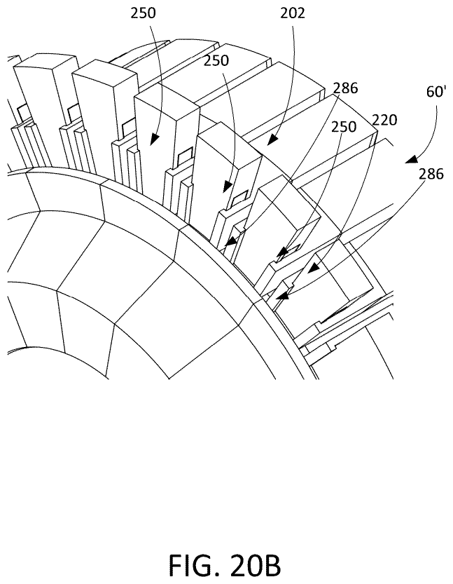

FIG. 20A is another perspective view of the damaged fan disc 60′ of FIG. 19A, and FIG. 20B is a detailed view of a portion of the damaged fan disc of FIG. 20A. As illustrated in FIG. 20B, each third piece 250 selectively masks a respective post 86′ such that second window 286 formed by that third piece 250 and the second piece 220 in contact with that third piece 250 leaves exposed the second wear plate 96′ (see FIGS. 4B and 16A) of that post 86′. In this manner, each masking system 200 including a first piece 202, a second piece 220, and a third piece 250 may selectively mask the posts 86′ and stops 74 such that first wear plate 94′ and second wear plate 96′ of each post 86′ of the damaged fan disc 60′ are exposed and accessible for repair.

Once the damaged fan disc 60′ is masked using masking systems 200 as discussed herein, all (or a subset of) the first wear plates 94′ and second wear plates 96′ may be repaired. In some examples, the repair process may involve coating the first wear plates 94′ and second wear plate 96 using a thermal spray technique, such as air plasma spraying (APS), vacuum plasma spraying (VPS), low pressure plasma spraying (LPPS), high velocity oxygen fuel spraying (HVOF), et cetera. As one example, the first wear plates 94′ and second wear plates 96′ may be coated using HVOF. To spray a component using HVOF, a mixture of fluid fuel and oxygen may be fed into a combustion chamber and ignited. The resultant gas may have an extremely high temperature and pressure, which may be ejected through a nozzle at supersonic speeds. Powder may be injected in the high velocity gas stream, and the gas stream may cause the powder to partially melt. The stream of hot gas and powder may be directed towards the surface to be coated. The resulting coating may be dense, have low porosity and high bond strength, and may provide corrosion resistance and other benefits.

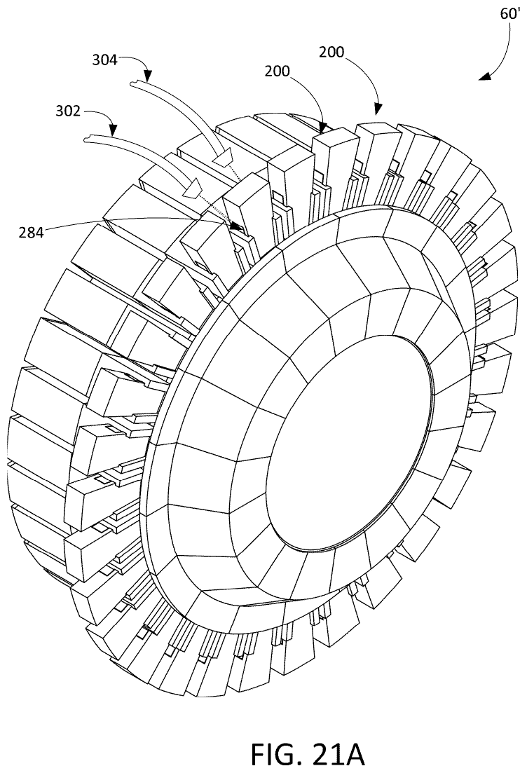

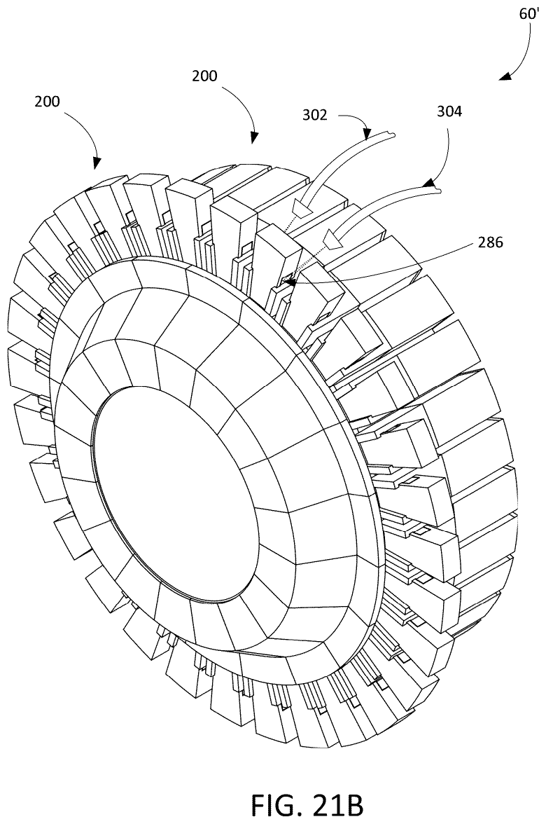

FIGS. 21A and 21B show an example thermal spray system having spray nozzles 302 and 304. As illustrated in FIG. 21A, thermal spray nozzle 302 may be used to coat first wear plate 94′ (see FIG. 5B) of damaged fan disc 60′ via first window 284; and, as illustrated in FIG. 21B, thermal spray nozzle 304 may be used to coat second wear plate 96′ of damaged fan disc 60′ via second window 286. The damaged fan disc 60′ and/or the spray system may be moved relative to the other of the damaged fan disc 60′ and the spray system to allow each of the first wear plate 94′ and second wear plate 96′ to be repaired. In some examples, the first wear plates 94′ and second wear plates 96′ may be blasted with abrasive media (after the damaged fan disc 60′ has been masked as described herein) in preparation for the thermal spray process. The first wear plates 94′ and second wear plates 96′ may, in some examples, also be machined after the thermal spray process to complete the repair process. In this way, the masking system 200 may allow the damaged fan disc 60′ to be selectively masked, e.g., for repair, without the need to laboriously cover the damaged fan disc 60′ with heat-resistant tape.

In some aspects of the disclosure, all or part of the masking system 200 may be additively manufactured. For example, one or more of first piece 202, second piece 220, third piece 250, and fourth piece 270 may be additively manufactured using a high-temperature, low elongation material that can repeatedly withstand the thermal spray processes. The phrase “high-temperature material” is defined herein to mean a material that has a heat distortion temperature of at least about 300° C. The phrase “high-temperature process” is defined herein to mean a process having associated therewith a temperature of at least about 300° C., such as a thermal coating (e.g., HVOF coating) or other high-temperature process.

In some examples of the disclosure, one or more of first piece 202, second piece 220, third piece 250, and fourth piece 270 may be additively manufactured using 3D 3955 from Loctite®, which is a halogen free high-temperature and high-modulus material having a shore hardness of between about 80 D and about 85 D. In some examples, one or more of first piece 202, second piece 220, third piece 250, and fourth piece 270 may be additively manufactured using e.g., resins, pellets, filaments, powders, and/or other suitable materials having a shore hardness of between about 60 D and about 105 D, and in some examples, between about 70 D and about 95 D. The material used to manufacture the first piece 202, second piece 220, third piece 250, and fourth piece 270 may be high-temperature material and may stand up to the exorbitant temperatures encountered during thermal spray processes. For example, the material used to manufacture the one or more of first piece 202, second piece 220, third piece 250, and fourth piece 270 may be able to withstand temperatures above about 300° C., above about 400° C., and/or above about 500° C.

The masking system 200 may only be configured on the damaged fan disc 60′ in one orientation. For example, the first piece 202 may only be configured on stop 74 in one orientation to allow the extended portion 219 of rear wall 218 of first piece 202 (see FIGS. 8A-8B) to abut overhanging portion 81 (see FIG. 4B) of top wall 80 of the respective stop 74. Such may minimize or eliminate the potential for improperly assembling the masking system 200.

The masking system 200 may be reusable. The masking system 200 may thus be used to selectively mask a plurality of damaged fan discs 60′, which may reduce costs associated with repairing this plurality of damaged fan discs 60′. In some examples, the masking system 200 may be toolless; that is, the masking system 200 may be configured by hand on the damaged fan disc 60′ to selectively mask same without the need for any tools. Similarly, once the repair process(es) are completed, the masking system 200 may be disassociated from the fan disc 60′ by hand and without the use of any tools. For instance, each of the first piece 202, second piece 220, and third piece 250 may be configured atop stop 74, and disassociated from stop 74 after the repair process(es) are complete, by hand and without the use of any tools.

The masking system 200, as described herein, is a multi-component system. From time to time, one or more components (e.g., any one of the first piece 202, second piece 220, third piece 250, and fourth piece 270) of the masking system 200 may get damaged. The segmented nature of the masking system 200 may allow for only that component of the masking system 200 to be replaced and/or repaired, without having to manufacture a new masking system 200 in its entirety. Such may further reduce the costs associated with manufacturing and using the masking system 200.

While the masking system 200 has been described herein with reference to a fan disc 60, the masking system 200 may also be used to selectively mask other gas turbine components, such as turbine discs, compressor disc, et cetera. The masking system 200 may likewise be used to selectively mask other components in other industries (e.g., rims for use in the automotive industry).

As used herein, the terms “first,” “second,” “third”, and “fourth” may be used interchangeably to distinguish one component from another and are not intended to signify location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The singular forms “a,” “an,” and “the” include plural references unless the context clearly dictates otherwise.

Many different arrangements of the various components depicted, as well as components not shown, are possible without departing from the spirit and scope of the present disclosure. Embodiments of the present disclosure have been described with the intent to be illustrative rather than restrictive. Alternative embodiments will become apparent to those skilled in the art that do not depart from its scope. A skilled artisan may develop alternative means of implementing the aforementioned improvements without departing from the scope of the present

It will be understood that certain features and subcombinations are of utility and may be employed without reference to other features and subcombinations and are contemplated within the scope of the claims. Not all steps listed in the various figures need be carried out in the specific order described.

The disclosure claimed is:

1. A masking system for selectively masking a component, the masking system comprising:
a first piece having a groove;
a second piece having a projection, a first channel, and a second channel; and
a third piece having a first wall, a second wall, a first sidewall, and a second sidewall, the first sidewall having a first notch;
wherein:
the groove is configured to receive the projection to connect the first piece and the second piece; and
the second wall of the third piece is configured to be insertably received by the first channel and the second channel such that a portion of the component is accessible via the first notch.

2. The masking system of claim 1, wherein the second piece has a top wall that includes a cutout.

3. The masking system of claim 2, wherein the first channel and the second channel are accessible via the cutout.

4. The masking system of claim 1, wherein the groove is a frusto-rectangular groove.

5. The masking system of claim 4, wherein the projection is a frusto-rectangular projection.

6. The masking system of claim 1, further including a fourth piece, the fourth piece having a first wall and a second wall connected by an angled wall.

7. The masking system of claim 1, wherein the component is a gas turbine component.

8. The masking system of claim 1, wherein the component is a fan disc.

9. The masking system of claim 8, wherein the fan disc includes a post having a wear plate.

10. The masking system of claim 1, wherein the portion is a wear plate.

11. The masking system of claim 1, wherein a height of the second wall is greater than a height of the first wall.

12. The masking system of claim 1, wherein the masking system is toolless.

13. A masking system for selectively masking a disc, the disc having a stop, the stop including a post with a wear plate, the masking system comprising:
a first piece;
a second piece having a first channel and a second channel, the first channel opposing the second channel; and
a third piece having a first wall, a second wall, a first sidewall, and a second sidewall, the first sidewall having a first notch;
wherein:
the first piece is configured to be connected to the second piece in an end-to-end configuration; and
the second wall of the third piece is configured to be insertably received by the first channel and the second channel such that the first notch corresponds to the wear plate when the third piece is on the post.

14. The masking system of claim 13, wherein:
the post includes a second wear plate that opposes the wear plate; and
the second sidewall includes a second notch which corresponds to the second wear plate when the second wall is insertably received by the first channel and the second channel.

15. The masking system of claim 13, including a fourth piece having a notch configured to interface with a rim of the disc.

16. The masking system of claim 13, wherein the disc is a fan disc of a gas turbine.

17. A masking system for selectively masking a component, the masking system comprising:
a first piece;
a second piece having a first channel and a second channel; and
a third piece having a first wall, a second wall, a first sidewall, and a second sidewall, the first sidewall having a first notch;
wherein:
the first piece is configured to be connected to the second piece; and
the second wall of the third piece is configured to be insertably received by the first channel and the second channel such that a portion of the component is accessible via the first notch.

18. The masking system of claim 17, wherein the first piece has a frusto-rectangular groove and the second piece has a frusto-rectangular projection.

19. The masking system of claim 17, wherein the first piece and the second piece are connected in an end-to-end configuration.

20. The masking system of claim 17, wherein each of the first piece, the second piece, and the third piece is additively manufactured using a high-temperature material.
